(19) United States
(12) Patent Application Publication
(10) Pub. No.: US 2025/0121384 A1
(43) Pub. Date: Apr. 17, 2025

(54) Dual-Cap Spray Nozzle and Selective-Spray System With Dual-Cap Spray Nozzles

(71) Applicant: Centure Applications LTD, Tel Aviv (IL)

(72) Inventors: Eran Beck, Tel Aviv (IL); Itzhak Khait, Kibbutz Ein Zivan (IL)

(21) Appl. No.: 18/763,026

(22) Filed: Jul. 3, 2024

Related U.S. Application Data
(60) Provisional application No. 63/589,456, filed on Oct. 11, 2023.

(51) Int. Cl. B05B 1/16; A01M 7/00; B05B 1/20; B05B 12/12

(52) U.S. Cl. CPC B05B 1/169; A01M 7/0042; A01M 7/0089; B05B 1/20; B05B 12/122; B05B 12/124; B05B 12/126

(57) ABSTRACT

A dual-cap nozzle comprises a housing having a cavity to receive a liquid; a first nozzle cap attached to the housing, the first nozzle cap defining a first nozzle channel that is fluidly coupled to the cavity; and a second nozzle cap attached to the housing, the second nozzle cap defining a second nozzle channel that is fluidly coupled to the cavity. The first and second nozzle caps extend along first and second axes, respectively. An offset angle between the first and second axes is greater than or equal to about 0 degrees and less than or equal to about 45 degrees.

### CROSS-REFERENCE TO RELATED APPLICATIONS

This application claims priority to U.S. Provisional Application No. 63/589,456, titled “Dual-Cap Spray Nozzle And Selective-Spray System With Dual-Cap Spray Nozzles,” filed on Oct. 11, 2023, which is hereby incorporated by reference.

### TECHNICAL FIELD

This application relates generally to agricultural spray systems.

### BACKGROUND

Agricultural spray systems include spray booms with nozzles to spray an agricultural field.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a multi-cap nozzle comprising a housing having a cavity to receive a liquid; a first nozzle cap attached to the housing, the first nozzle cap defining a first nozzle channel that is fluidly coupled to the cavity; and a second nozzle cap attached to the housing, the second nozzle cap defining a second nozzle channel that is fluidly coupled to the cavity, wherein the first and second nozzle caps extend along first and second axes, respectively, and an offset angle between the first and second axes is greater than or equal to about 0 degrees and less than or equal to about 45 degrees.

In one or more embodiments, the first axis is oriented at a first angle with respect to a vertical axis, the first angle greater than or equal to about 0 degrees and less than or equal to about 20 degrees, the second axis is oriented at a second angle with respect to the vertical axis, the second angle greater than or equal to about 10 degrees and less than or equal to about 55 degrees, and the second angle is greater than or equal to the first angle. In one or more embodiments, the first angle is about 6 degrees and the second angle is about 12 degrees. In one or more embodiments, the offset angle is greater than or equal to about 2 degrees and less than or equal to about 10 degrees.

In one or more embodiments, the multi-cap nozzle further comprises a third nozzle cap attached to the housing, the third nozzle cap defining a third nozzle channel that is fluidly coupled to the cavity, wherein the third nozzle cap extends along a third axis, and the offset angle is between the first, second, and third axes.

Another aspect of the invention is directed to an agricultural spray system comprising an agricultural vehicle; a tank mounted on the agricultural vehicle, the tank configured to hold one or more liquid chemicals for treating weeds in an agricultural field; a spray boom attached to the agricultural vehicle, the spray boom extending along a horizontal axis; and at least one multi-cap nozzle mounted on the spray boom, each multi-cap nozzle fluidly coupled to the tank and comprising a housing having a cavity to receive the one or more specific liquid chemicals; a first nozzle cap attached to the housing, the first nozzle cap defining a first nozzle channel that is fluidly coupled to the cavity; and a second nozzle cap attached to the housing, the second nozzle cap defining a second nozzle channel that is fluidly coupled to the cavity, wherein the first and second nozzle caps extend along first and second axes, respectively, and an offset angle between the first and second axes is greater than or equal to about 0 degrees and less than or equal to about 45 degrees.

In one or more embodiments, the first axis is oriented at a first angle with respect to a vertical axis, the vertical axis orthogonal to the horizontal axis, the first angle greater than or equal to about 0 degrees and less than or equal to about 20 degrees, the second axis is oriented at a second angle with respect to the vertical axis, the second angle greater than or equal to about 10 degrees and less than or equal to about 55 degrees, and the second angle is greater than or equal to the first angle. In one or more embodiments, the first angle is about 6 degrees and the second angle is about 12 degrees. In one or more embodiments, the first and second nozzle caps are oriented away from a direction of travel of the agricultural vehicle.

In one or more embodiments, the spray system further comprises at least one fluid line, each fluid line fluidly coupling a respective multi-cap nozzle to the tank; at least one valve, each valve fluidly coupled to a respective fluid line and having an open state in which fluid flows from the tank to the respective multi-cap nozzle and a closed state in which a flow of the fluid from the tank to the respective multi-cap nozzle is obstructed; and one or more processors in electrical communication with the valve(s), the processor(s) configured to cause the valve(s) to transition between the open state and the closed state at a frequency and a duty cycle that minimizes an overlap between a first spray area of the first nozzle cap and a second spray area of the second nozzle cap. In one or more embodiments, the processor(s) is/are configured to dynamically determine the frequency as a function of a current speed of the agricultural vehicle, a current height of the spray boom, and the first and second angles, and the processor(s) is/are configured to dynamically determine the duty cycle as a function of the current speed of the agricultural vehicle and a maximum speed of the agricultural vehicle.

In one or more embodiments, the processor(s) is/are configured to cause at least one of the valve(s) to transition to the open state when the second nozzle cap is positioned to spray a proximal end of a target field area and the first nozzle cap is positioned to spray a proximal field area, the agricultural vehicle reaching the proximal field area before the target field area as the agricultural vehicle moves along the direction of travel, the processor(s) is/are configured to cause the at least one of the valve(s) to the closed state after the first nozzle cap sprays a distal end of the target field area and the second nozzle cap sprays a distal field area, the agricultural vehicle reaching the distal field area after the target field area as the agricultural vehicle moves along the direction of travel, and the target field area is between and neighboring the proximal field area and the distal field area.

In one or more embodiments, the spray system further comprises a plurality of image sensors mounted on the spray boom and configured to capture images of the agricultural field in a direction of travel of the agricultural vehicle, each image sensor having a field of view that is aligned with and corresponds with one or more of the multi-cap nozzles; and one or more computers in electrical communication with the image sensors to receive captured images from the image sensors, the computer(s) configured to detect target weed(s) in one or more of the captured images using a trained machine learning (ML) model, the trained ML model having been trained with first and second training images of agricultural fields, the first training images including the target weed(s), the second training images not including the target weed(s), the computer(s) producing an output signal that causes one or more of the valves to transition between an inactive state and an active state, the one or more valves associated with the one or more of the captured images in which the target weed(s) is/are detected, wherein in the inactive state, the one or more valves are in the closed state, in the active state, the one or more valves transition between the open state and the closed state at the frequency and the duty cycle, the field of view of each image sensor has a respective width and a respective length to define a respective field area, the respective width corresponding to a spray width of a respective multi-cap nozzle, the respective length corresponding to a length of time that a respective valve for the respective multi-cap nozzle is in the active state, the respective width is measured with respect to the horizontal axis, the respective length is measured with respect to a length axis that is orthogonal to the horizontal axis and to a vertical axis, when the respective valve transitions from the inactive state to the active state at a beginning of the length of time, only the first nozzle cap of the respective multi-cap nozzle sprays the proximal field area, and when the respective valve transitions from the active state to the inactive state at an end of the length of time, only the second nozzle cap of the respective multi-cap nozzle sprays the distal field area.

In one or more embodiments, the spray system further comprises the tank comprises a selective-spot spray (SSP) tank configured to hold one or more specific liquid chemicals for treating one or more target weeds growing in the agricultural field. In one or more embodiments, the spray system further comprises at least one fluid line, each fluid line fluidly coupling a respective multi-cap nozzle to the SSP tank; respective first and second valves associated with each multi-cap nozzle, the respective first valve fluidly coupled to a respective first nozzle cap, the respective second valve fluidly coupled to a respective second nozzle cap; and one or more processors in electrical communication with the respective first and second valves of each multi-cap nozzle, the processor(s) configured to transition the respective first and second valves of each multi-cap nozzle between a respective open state and a respective closed state at a frequency, a duty cycle, and a relative phase that minimizes an overlap between a respective first spray area of the respective first nozzle cap and a respective second spray area of the respective second nozzle cap.

In one or more embodiments, the tank comprises a broadcast tank configured to hold one or more general-application liquid chemicals for preventing the weeds from growing.

Another aspect of the invention is directed to a method for spraying an agricultural field, comprising in a system that includes a spray boom attached to an agricultural vehicle, and at least one multi-cap nozzle mounted on the spray boom, each multi-cap nozzle fluidly coupled to a tank mounted on the agricultural vehicle through a respective valve, the tank configured to hold one or more liquid chemicals for treating weeds in the agricultural field, wherein each multi-cap nozzle comprises a housing having a cavity to receive the one or more specific liquid chemicals; a first nozzle cap attached to the housing, the first nozzle cap defining a first nozzle channel that is fluidly coupled to the cavity; and a second nozzle cap attached to the housing, the second nozzle cap defining a second nozzle channel that is fluidly coupled to the cavity, wherein the first and second nozzle caps extend along first and second axes, respectively, and an offset angle between the first and second axes is greater than or equal to about 0 degrees and less than or equal to about 45 degrees, the method comprising determining, with a controller for the multi-cap nozzle(s), a current speed of the agricultural vehicle; determining, with the controller, a current height of the spray boom; determining, with the controller and using at least the current height, the current speed, and the offset angle, a frequency to transition the respective valve between an open state and a closed state that minimizes an overlap between a first spray area of the first nozzle cap and a second spray area of the second nozzle cap; determining, with the controller and using at least the current speed, a duty cycle of the respective valve; and spraying the agricultural field using each multi-cap nozzle at the frequency and duty cycle of the respective valve.

In one or more embodiments, the duty cycle is determined using the current speed and a maximum speed of the agricultural vehicle. In one or more embodiments, the duty cycle is calculated as a ratio of the current speed and the maximum speed.

In one or more embodiments, the method further comprises dynamically varying the frequency as a function of a current speed of the agricultural vehicle, a current height of the spray boom, and the offset angle. In one or more embodiments, the method further comprises determining an equivalent distance that the agricultural vehicle travels during an off portion of the duty cycle at the current speed; and when the equivalent distance is larger than a maximum off distance, dynamically increasing the frequency until the equivalent distance is lower than the maximum off distance.

In one or more embodiments, the method further comprises automatically capturing, with a plurality of cameras attached to the spray boom, a respective image of a respective region of an agricultural field, each region at a predetermined distance from the spray boom, each image associated with a respective multi-cap nozzle; automatically analyzing, with a trained machine learning (ML) model running on a computer, each image for a presence of at least one target weed, the trained ML model having been trained with first and second training images of agricultural fields, the first training images including the target weed(s), the second training images not including the target weed(s); automatically detecting, with the trained ML model, the at least one target weed in one or more images; and automatically selectively spraying one or more of the respective regions of the agricultural field using one or more of the multi-cap nozzle(s) associated with the one or more images where the at least one target weed is detected.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is an isometric view of a dual-sprayer system according to an embodiment.

FIG. 2 is a side view of a dual sprayer system according to another embodiment.

FIG. 3 is a block diagram of a system for selectively applying a treatment to a target region according to an embodiment.

FIG. 4 is a simplified block diagram of fluid and electrical circuits for the dual-sprayer system according to an embodiment.

FIG. 5A is a simplified block diagram of a dual-cap nozzle according to an embodiment.

FIG. 5B is a simplified block diagram of a multi-cap nozzle according to an embodiment.

FIG. 5C is a simplified block diagram of a dual-cap nozzle according to an embodiment.

FIG. 6 is a simplified block diagram of a spray boom according to an embodiment.

FIG. 7 is a flow chart of a computer-implemented method for operating dual-cap nozzles in a sprayer system.

FIG. 8 is a simplified end view of the spray boom illustrated in FIG. 6 when one of the dual-cap nozzles is aligned with the beginning of a target field area in which one or more weeds is/are detected.

FIG. 9 is a simplified end view of the spray boom illustrated in FIG. 6 when one of the dual-cap nozzles is aligned with the end of a field area in which one or more weeds is/are detected.

FIG. 10 is a graph that represents the spatial volumetric distribution of spray in the embodiment illustrated in FIGS. 8 and 9.

FIGS. 11A and 11B illustrates example graphs that model a dual-cap nozzle and a single-cap nozzle, respectively, operated at a 50% duty cycle.

FIGS. 12A and 12B illustrates example graphs that model a dual-cap nozzle and a single-cap nozzle, respectively, operated at a 33% duty cycle.

FIG. 13 is a flow chart of a method for selectively spraying an agricultural field according to an embodiment.

FIG. 14 is a flow chart of a method for spraying a target field area of an agricultural field using a multi-cap nozzle according to an embodiment.

### DETAILED DESCRIPTION

An agricultural spray system includes at least one multi-cap spray nozzle that is/are mounted on a spray boom and that is/are fluidly coupled to a spray tank. Each multi-cap spray nozzle includes at least a first nozzle cap and a second nozzle cap. The first nozzle cap is oriented at a first angle with respect to a vertical axis. The second nozzle cap is oriented at a second angle with respect to a vertical axis. An offset angle is formed between the first and second nozzle caps. The first and second angles determine the respective spray areas of the first and the nozzle caps.

The multi-cap spray nozzle(s) can be operated at a variable frequency and at a variable duty cycle. The frequency can be set to reduce overlap in the first and second spray areas of the first and second nozzle caps, respectively. The frequency can be determined based on the height of the spray boom and/or of the dual-cap spray nozzles, the first and second angles, and/or the speed of the agricultural vehicle. The duty cycle can be set so that the multi-cap spray nozzle(s) apply the same (or about the same) volume of liquid chemical per unit area of agricultural field regardless of the speed of the agricultural vehicle.

When the multi-cap spray nozzle(s) approach a target field area, one or more of the multi-cap spray nozzle(s) can be transitioned from an inactive state to an active state. In the inactive state, a respective valve that fluidly couples a respective multi-cap spray nozzle to the spray tank is closed to obstruct fluid flow to the respective multi-cap spray nozzle. In the active state, the respective valve is opened to allow fluid to flow into the respective multi-cap spray nozzle. While in the active state, the valve can be opened and closed at a variable frequency and/or at a variable duty cycle.

In one example, when at least one weed is detected in an image captured by an image sensor, such as a camera mounted on the spray boom, a corresponding multi-cap spray nozzle can be transitioned from the inactive state to the active state, such that the target field area corresponds to the field of view of the image sensor that captured the image. In another example, the target field area can be based, at least in part, on historical weed data for the agricultural field.

In another example, the multi-cap spray nozzle(s) can be used to broadcast spray an agricultural field.

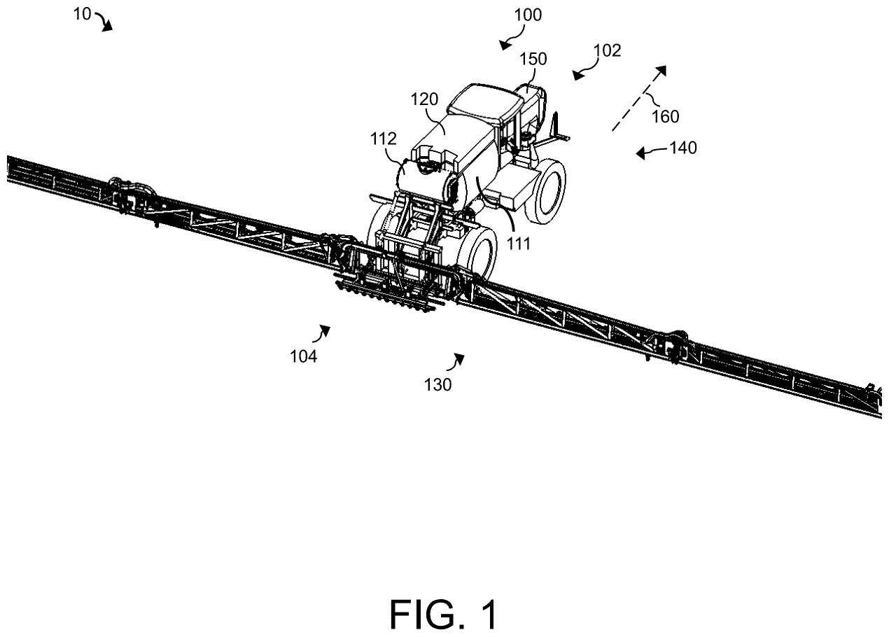

FIG. 1 is an isometric view of a dual-sprayer system 10 according to an embodiment. The system 10 includes an agricultural vehicle 100, a broadcast tank 111, an SSP tank 112, a rinse tank 120, and a spray boom 130.

The broadcast tank 111 is mounted on the agricultural vehicle 100 and can be an original-equipment manufacturer (OEM) tank and/or a primary tank for the agricultural vehicle 100. The agricultural vehicle 100, the broadcast tank 111, the rinse tank 120, pumps, and/or corresponding fluid lines can comprise an OEM broadcast spray system 140. Alternatively, the agricultural vehicle 100, the broadcast tank 111, the rinse tank 120, and/or the corresponding fluid lines can be aftermarket and/or retrofit components.

The broadcast tank 111 is configured to hold one or more general-application liquid chemicals (e.g., herbicides) to be sprayed broadly onto an agricultural field using the spray boom 130, which is attached (e.g., releasably attached) to the agricultural vehicle 100. The broadcast liquid chemicals can be configured to prevent weeds and/or other undesirable plants from growing. Additionally or alternatively, the broadcast liquid chemicals can be configured to treat one or more existing weeds growing in the field. One or more first fluid lines fluidly couple the broadcast tank 111 to broadcast nozzles on the spray boom 130.

The SSP tank 112 is mounted on the agricultural vehicle 100 such as on a frame attached to the agricultural vehicle 100. The SSP tank 112 can be an aftermarket tank that is retrofit onto the agricultural vehicle 100. Alternatively, the SSP tank 112 can be an OEM SSP tank. The SSP tank 112 is configured to hold one or more target-application or specific chemical(s) (e.g., herbicide(s)) that is/are designed to target one or more weeds growing in the agricultural field. Additionally or alternatively, the SSP tank 112 can include one or more fertilizers and/or nitrogen-containing compounds. One or more second fluid lines fluidly couple the SSP tank to SSP nozzles on the spray boom 130. The specific chemical(s) in the SSP tank 112 are selectively sprayed using the SSP nozzles in response to imaging of the agricultural field and analysis/detection by one or more trained machine learning models. Valves coupled to the SSP nozzles can be opened and closed to selectively spray the detected weeds.

The rinse tank 120 is fluidly coupled to the broadcast tank 111 and to the SSP tank 112. Water and/or another liquid stored in the rinse tank 120 can be used to rinse the broadcast tank 111 and the SSP tank 112 after each tank 111, 112 is emptied.

The selective application of the specific chemical(s) stored in the SSP tank 112 allows the volumetric capacity of the SSP tank 112 to be smaller than the volumetric capacity of the broadcast tank 111. In one example, the volumetric capacity of the broadcast tank 111 can be at least about 3 times greater than the volumetric capacity of the SSP tank 112. For example, the volumetric capacity of the broadcast tank 111 can be about 3 to about 20 times, including about 5 times, about 10 times, about 15 times, and any value or range between any two of the foregoing values, greater than the volumetric capacity of the SSP tank 112. Conversely, the volumetric capacity of the SSP tank 112 can be less than or equal to about 30% the volumetric capacity of the broadcast tank 111. For example, the volumetric capacity of the SSP tank 112 can be about 5% to about 30%, including about 10%, about 15%, about 20%, about 25%, and any value or range between any two of the foregoing values, lower than the volumetric capacity of the broadcast tank 111.

The relative sizes (volumetric capacities) of the broadcast tank 111 and the SSP tank 112 can be configured such that, on average, each tank 111, 112 will be emptied (from a respective full tank) at approximately the same time. For example, the respective chemicals stored in each tank 111, 112 can be used, on average, at the same relative volumetric rate compared to the respective size of the tank 111, 112. This allows the refilling of tanks 111, 112 to be synchronized which can improve efficiency.

The engine 150 for the agricultural vehicle 100 can be replaced with a motor when the agricultural vehicle 100 is electric or can include both an engine and a motor when the agricultural vehicle 100 is a hybrid vehicle. In any case, the agricultural vehicle 100 includes a mechanical drive system that powers the agricultural vehicle 100 and the wheels.

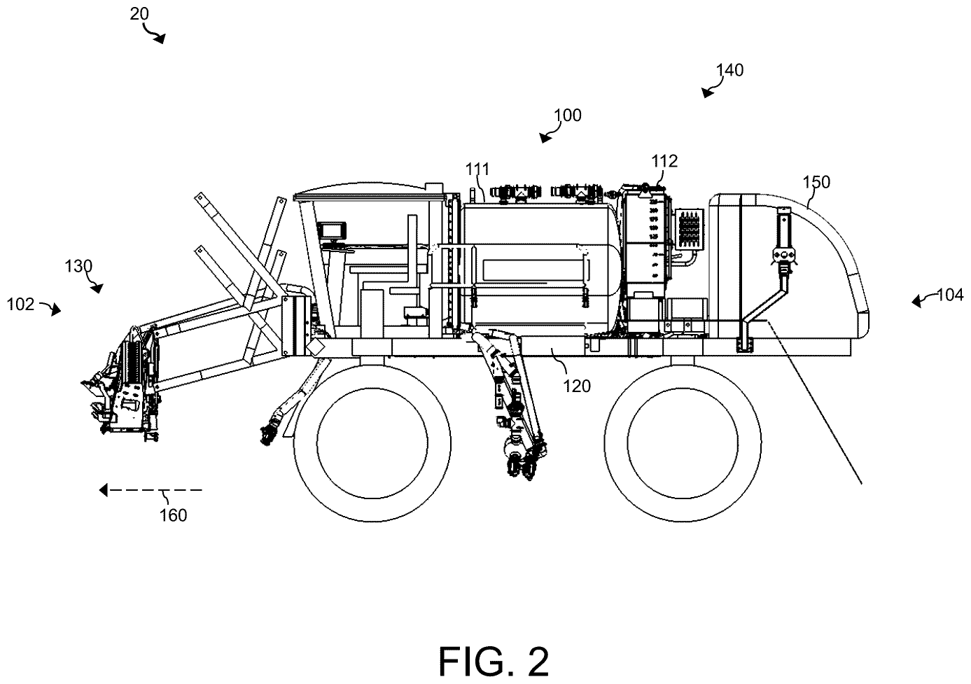

The spray boom 130 is attached to the back 104 of the agricultural vehicle 100 in a first configuration of the system 10 such that the agricultural vehicle 100 pulls the spray boom 130 as the agricultural vehicle 100 drives forward (e.g., in direction 160). In a second configuration of the system 10, the spray boom 130 can be attached to the front 102 of the agricultural vehicle 100 such that the agricultural vehicle 100 pushes the spray boom 130 as the agricultural vehicle 100 drives forward. An example of the second configuration is illustrated in FIG. 2, which is a side view of a dual sprayer system 20 according to another embodiment. System 20 is the same as system 10 except for the locations of the broadcast tank 111, the SSP tank 112, and the rinse tank 120 and the configuration/location of the spray boom 130.

The broadcast tank 111 can be optional in some embodiments.

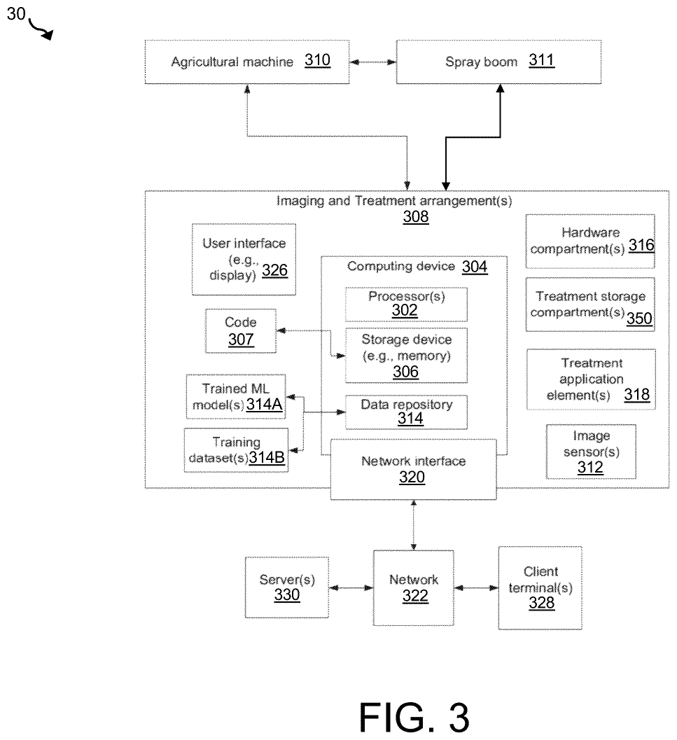

FIG. 3 is a block diagram of a system 30 for selectively applying a treatment to a target region according to an embodiment. System 30 can be the same as system(s) 10 and/or 20.

System 30 includes one or more imaging and treatment arrangements 308 connected to and/or mounted on an agricultural machine 310, for example, a tractor, an airplane, an off-road vehicle, or a drone. Agricultural machine 310 can be the same as agricultural machine 100. Agricultural machine 310 can include and/or can be connected to a spray boom 311 and/or to another boom. Spray boom 311 can be the same as spray boom 130. Imaging and treatment arrangements 308 may be arranged along a length of the agricultural machine 310 and/or of the spray boom 311. For example, the imaging and treatment arrangements 308 can be evenly spaced every 1-3 meters along the length of spray boom 311. Spray boom 311 may be long, for example, 10-50 meters, or another length. Spray boom 311 may be pushed or pulled by agricultural machine 310. In another embodiment, the system 30 only includes one imaging and treatment arrangement 308.

An example imaging and treatment arrangement 308 is depicted for clarity, but it is to be understood that system 30 may include multiple imaging and treatment arrangements 308. It is noted that each imaging and treatment arrangement 308 may include all components described herein. Alternatively, one or more imaging and treatment arrangements 308 can share one or more components, for example, multiple imaging and treatment arrangements 308 can share a common computing device 304, common memory 306, and/or common processor(s) 302.

Each imaging and treatment arrangement 308 includes one or more image sensors 312 that acquire images of the agricultural field. Examples of an image sensor 312 include a color sensor, optionally a visible light-based sensor, for example, a red-green-blue (RGB) sensor such as CCD and/or CMOS sensors, and/or other cameras (e.g., cameras 640) and/or other sensors such as an infra-red (IR) sensor, a near-infrared sensor, an ultraviolet sensor, a fluorescent sensor, a LIDAR sensor, an NDVI sensor, a three-dimensional sensor, and/or a multispectral sensor. Image sensor(s) 312 are arranged and/or positioned to capture images of a portion of the agricultural field (e.g., located in front of image sensor(s) 312 and along a direction of motion of agricultural machine 310).

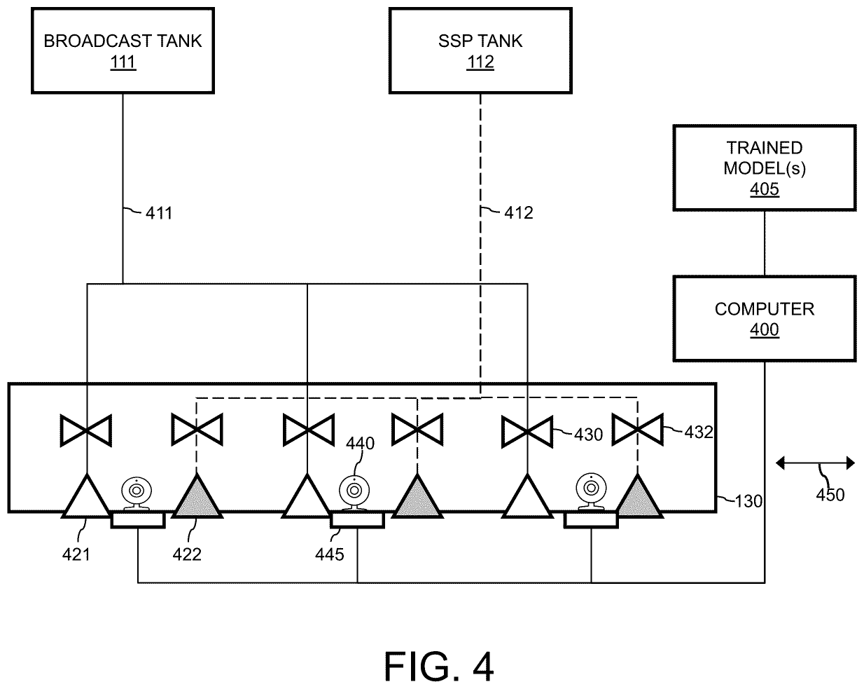

A computing device 304 receives the image(s) from image sensor(s) 312, for example, via a direct connection (e.g., local bus and/or cable connection and/or short-range wireless connection), a wireless connection and/or via a network. The image(s) are processed by processor(s) 302, which feeds the image into a trained machine learning (ML) model 314A (e.g., trained on a training dataset(s) 314B that include training images of agricultural fields with target weeds and training images of agricultural fields without target weeds). Training dataset(s) 314B are used to train the trained ML model 314A and may not be included in system 30 in some embodiments. The trained ML model 314A can be configured to detect a target growth, such as one or more weeds, within the image(s), that is separate from a desired growth (e.g., a crop). Additionally or alternatively, the trained ML model 314A can be configured to detect one or more target agricultural crops. One treatment storage compartment 350 may be selected from multiple treatment storage compartments according to the outcome of trained ML model 314A, for administration of a treatment by one or more treatment application element(s), as described herein. For example, an SSP tank (e.g., SSP tank 112) can be selected to provide treatment in response to the detection of a target weed. In some embodiments, only the valve(s) 430 (FIG. 4) associated with the camera 440 (FIG. 4) (or other image sensor(s) 312) and with the position(s) of the detected weed in the image(s) are activated to precisely target the detected weed. In contrast, the broadcast tank (e.g., broadcast tank 111) can continually apply treatment to all or substantially all areas of the agricultural field, for example as a preventative for future weed growth and/or as a general herbicide for existing weeds.

Hardware processor(s) 302 of computing device 304 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 302 may include a single processor, or multiple processors (homogenous or heterogeneous) arranged for parallel processing, as clusters and/or as one or more multi core processing devices.

Storage device (e.g., memory) 306 stores code instructions executable by hardware processor(s) 302, for example, a random-access memory (RAM), read-only memory (ROM), and/or a storage device, for example, non-volatile memory, magnetic media, semiconductor memory devices, hard drive, removable storage, and optical media (e.g., DVD, CD-ROM). Memory 306 stores code 307 that implements one or more features and/or instructions to be executed by the hardware processor(s) 302. Memory 306 can comprise or consist of solid-state memory and/or a solid-state device.

Computing device 304 may include a data repository 314 (e.g., storage device(s)) for storing data, for example, trained ML model(s) 314A which may include a detector component and/or a classifier component. The data repository 314 also stores the captured real-time images taken with the respective image sensor 312. The data repository 314 may be implemented as, for example, a computer memory, a local hard-drive, a solid-state drive, a solid-state memory, virtual storage, a removable storage unit, an optical disk, a storage device, and/or as a remote server and/or computing cloud (e.g., accessed using a network connection). Additional details regarding the trained ML model(s) 314A, the training dataset(s) 314B, and/or other components of system 30 are described in U.S. Pat. No. 11,393,049, titled “Machine Learning Models For Selecting Treatments For Treating an Agricultural Field,” which is hereby incorporated by reference.

In some embodiments, the data repository 314 can store historical data of an agricultural field. The historical data can represent the locations in the agricultural field where weeds were present in one or more prior years. The locations can be represented as global positioning system (GPS) coordinates or as other representations. The historical data can also represent the types of weeds that grew in the agricultural field in one or more prior years.

Computing device 304 is in communication with one or more treatment storage compartment(s) (e.g., tanks) 350 and/or treatment application elements 318 (e.g., including respective valves such as valves 430) that apply treatment for treating the field and/or plants growing on the field. There may be two or more treatment storage compartment(s) 350, for example, one or more compartments (e.g., SSP tank 112) storing chemical(s) specific to a target growth such as one or more weeds, and another one or more compartments (e.g., broadcast tank 111) storing broad chemical(s) that are non-specific to target growths such as designed for different types of weeds and/or for the prevention of weed growth. One or more of the treatment storage compartment(s) 350 can comprise a portion of a direct injection system. In an embodiment, the system 30 can include a first direct injection system for the chemical(s) specific to a target growth (e.g., one or more weeds) and/or a second direct injection system for the broad chemical(s) that are non-specific to target growths.

There may be one or multiple treatment application elements 318 connected to the treatment storage compartment(s) 350, for example, one or more spot sprayers (e.g., SSP nozzles 422 (FIG. 4)) connected to a first compartment (e.g., SSP tank 112) storing specific chemicals for one or more weeds, and one or more broad sprayers (e.g., broadcast nozzles 421 (FIG. 4)) connected to a second compartment (e.g., broadcast tank 111) storing non-specific chemicals for different types of weeds. A respective valve (e.g., valve 430 (FIG. 4)) can be opened and closed to drive fluid through each spot sprayer(s) 422 (FIG. 4). Alternatively, each spot sprayer 422 can include a respective valve (e.g., valve 430). The valves can be opened and closed at a duty cycle as described herein.

Other examples of treatments and/or treatment application elements 318 include: gas application elements that apply a gas, electrical treatment application elements that apply an electrical pattern (e.g., electrodes to apply an electrical current), mechanical treatment application elements that apply a mechanical treatment (e.g., sheers and/or cutting tools and/or high pressure-water jets for pruning crops and/or removing weeds), thermal treatment application elements that apply a thermal treatment, steam treatment application elements that apply a steam treatment, and laser treatment application elements that apply a laser treatment.

Computing device 304 and/or imaging and treatment arrangement 308 may include a network interface 320 for connecting to a network 322, for example, one or more of, a network interface card, an antenna, a wireless interface to connect to a wireless network, a physical interface for connecting to a cable for network connectivity, a virtual interface implemented in software, network communication software providing higher layers of network connectivity, and/or other implementations.

Computing device 304 and/or imaging and treatment arrangement 308 may communicate with one or more client terminals 328 (e.g., smartphones, mobile devices, laptops, smart watches, tablets, desktop computer) and/or with a server(s) 330 (e.g., web server, network node, cloud server, virtual server, virtual machine) over network 322. Client terminals 328 may be used, for example, to remotely monitor imaging and treatment arrangement(s) 308 and/or to remotely change parameters thereof. Server(s) 330 may be used, for example, to remotely collect data from multiple imaging and treatment arrangement(s) 308 optionally of different agricultural machines, for example, to create new training datasets and/or update exiting training datasets for updating the ML models with new images.

Network 322 may be implemented as, for example, the internet, a local area network, a wire-area network, a virtual network, a wireless network, a cellular network, a local bus, a point-to-point link (e.g., wired), and/or combinations of the aforementioned.

Computing device 304 and/or imaging and treatment arrangement 308 includes and/or is in communication with one or more physical user interfaces 326 that include a mechanism for user interaction, for example, to enter data (e.g., define threshold and/or set of rules) and/or to view data (e.g., results of which treatment was applied to which portion of the field).

Example physical user interfaces 326 include, for example, a touchscreen, a display, gesture activation devices, a keyboard, a mouse, and/or voice-activated software using speakers and a microphone. Alternatively, client terminal 328 serves as the user interface by communicating with computing device 304 and/or server 330 over network 322.

Treatment application elements 318 may be adapted for spot spraying and/or broad (e.g., band) spraying, for example as described in U.S. Provisional Patent Application No. 63/149,378, filed on Feb. 15, 2021, and/or in U.S. Pat. No. 11,393,049, which are hereby incorporated by reference.

System 30 may include a hardware component 316 associated with the agricultural machine 310 for dynamic adaption of the herbicide and/or fertilizer (applied by the treatment application element(s) 318 according to dynamic orientation parameter(s) computed by analyzing an overlap region of images captured by image sensors 312, for example as described in U.S. Provisional Patent Application No. 63/082,500, filed on Sep. 24, 2020, and/or in U.S. Pat. No. 11,393,049, which are hereby incorporated by reference.

FIG. 4 is a simplified block diagram of fluid and electrical circuits for a dual-sprayer system (e.g., dual-sprayer system 10, 20) according to an embodiment. One or more fluid lines 411 fluidly couple the broadcast tank 111 to a plurality of broadcast nozzles 421 on the spray boom 130. One or more fluid lines 412 fluidly couple the SSP tank 112 to a plurality of SSP nozzles 422 on the spray boom 130. The spray boom 130 extends along and/or parallel to a horizontal axis 450. Electromechanically actuated valves 430 (e.g., SSP valves) are located on the fluid line(s) 412 between each SSP nozzle 422 and the SSP tank 112. Electromechanically actuated valves 432 are located on the fluid line(s) 411 between each broadcast nozzle 421 and the broadcast tank 111.

Each valve 430, 432 can include a solenoid that allows the valve to open and close.

The state of each valve 430, 432 is controlled by a computer or controller 400 which is electrically coupled to each valve 430, 432. The computer/controller 400 can be the same as computing device 304. Additional computers and/or controllers can be provided. The computer/controller 400 selectively opens and closes each valve 430 when weeds are detected using images of the agricultural field that are obtained by cameras 440 and/or other image sensors (e.g., image sensor(s) 312) mounted on the spray boom 130, 311. In some embodiments, the valves 430, 432 can have a variable duty cycle and/or a variable frequency when in the on/open state. The variable duty cycle can correspond or relate to the speed of the agricultural vehicle 100, 310 such that the same or approximately the same volume of chemicals is applied per unit area of agricultural field regardless of the speed of the agricultural vehicle 100, 310. The computer 400 can include or can be electrically coupled to one or more pulse-width modulator (PWM) signal generators that can produce the control signals that vary the duty cycle of the valves 430, 432.

Lights 445 such as light-emitting diodes (LEDs) can be used provide light (e.g., flash) for the agricultural field. The cameras 440 and lights 445 are in electrical communication with the computer/controller 400 to detect weeds in the images using one or more trained machine learning models 405. The trained model(s) 405 can be trained using first images of the target weeds and second images that do not include the target weeds. The trained model(s) 405 can be the same as trained ML model(s) 314A. The field of view of each camera 440 and/or other image sensor(s) is aligned with and corresponds to the position of one or more SSP nozzle 422.

The fluid circuits for the broadcast tank 111 and the SSP tank 112 can include additional components, such as pumps, filters, sensors, and/or other components. In some embodiments, either the broadcast tank 411 (and associated broadcast nozzles 421) or the SSP tank (and associated SSP nozzles 422) is omitted such that the fluid and electrical circuits correspond to a single-tank system.

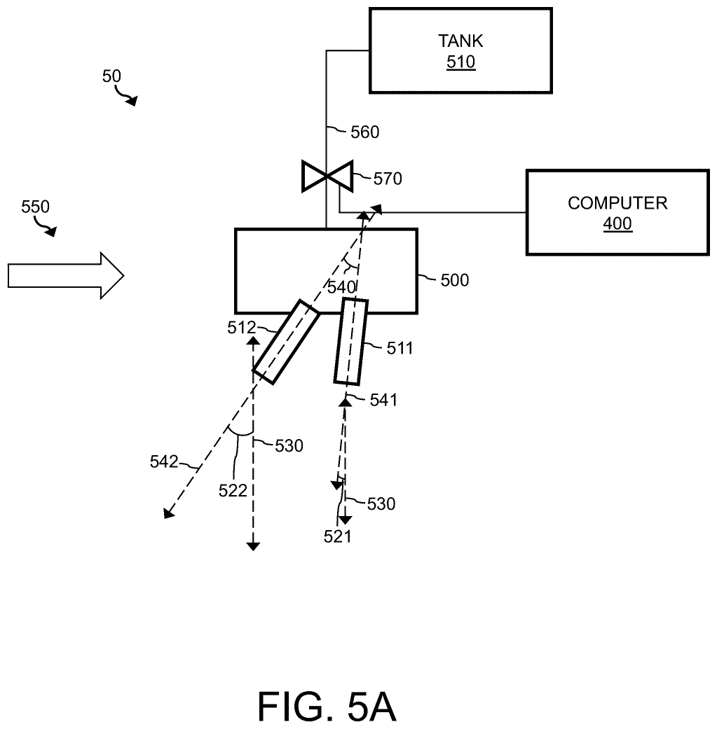

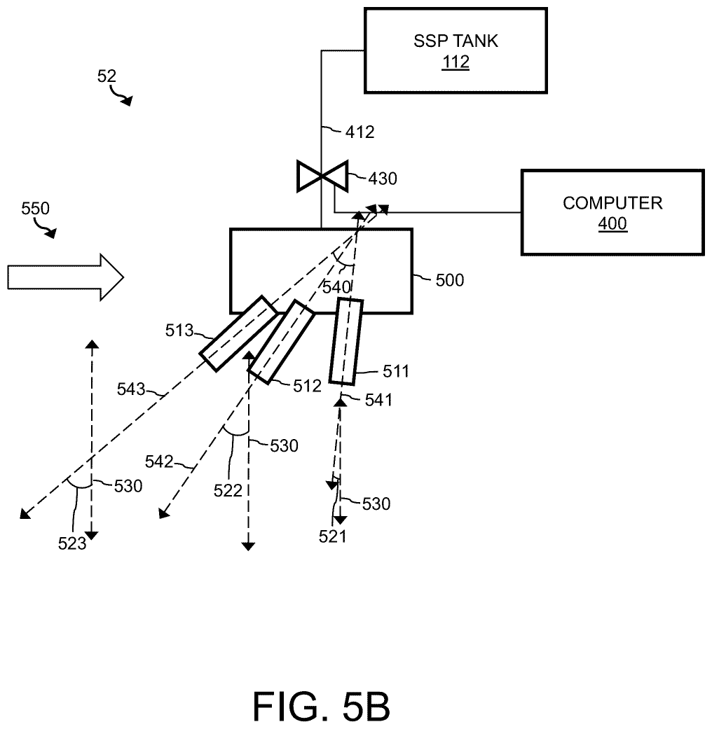

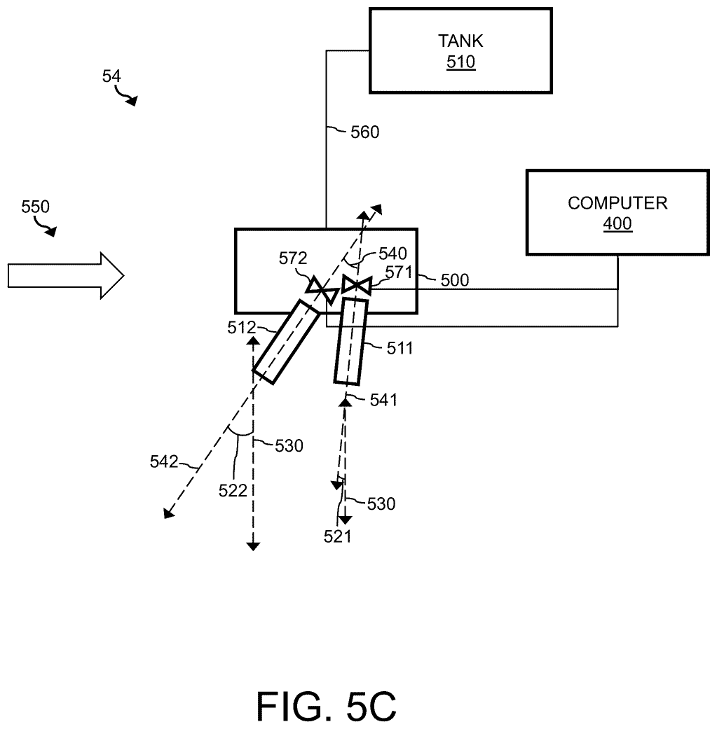

FIG. 5A is a simplified block diagram of a dual-cap nozzle 50 according to an embodiment. The dual-cap nozzle 50 can be the same as a broadcast nozzle 421 and/or an SSP nozzle 422. In some embodiments, at least one broadcast nozzle 421 is a dual-cap nozzle 50. In some embodiments, each broadcast nozzle 421 is a respective dual-cap nozzle 50.

The dual-cap nozzle 50 includes a chamber 500 and first and second nozzle caps 511, 512, respectively. The chamber 500 is configured to receive liquid chemicals from a tank 510 via fluid line(s) 560 when the valve 570 is open. The liquid chemicals are output in equal (or approximately) equal volumes/volumetric flow rates through the first and second nozzle caps 511, 512, which are fluidly coupled to the chamber 500. Thus, the volumetric flow rate through each nozzle cap 511, 512 is about half the volumetric flow rate through a single-nozzle cap. Tank 510 can be the same as broadcast tank 111 or SSP tank 112. When the tank 510 is the same as broadcast tank 111, fluid line(s) 560 and valve 570 can be the same as fluid line(s) 411 and valve 432, respectively. When the tank 510 is the same as SSP tank 112, fluid line(s) 560 and valve 570 can be the same as fluid line(s) 412 and valve 430, respectively.

The first nozzle cap 511 is oriented at a first angle 521 with respect to a vertical axis 530 and away from the direction of travel 550 of the agricultural vehicle 100. The first angle 521 can be measured between the vertical axis 530 and a first axis 541 along which the first nozzle cap 511 extends. The second nozzle cap 512 is oriented at a second angle 522 with respect to the vertical axis 530 and away from the direction of travel 550 of the agricultural vehicle 100. The second angle 522 can be measured between the vertical axis 530 and a second axis 542 along which the second nozzle cap 512 extends.

In another embodiment, the first and second nozzle caps 511, 512 are oriented towards the direction of travel 550.

The first angle 521 can be about 0 degrees to about 20 degrees including about 5 degrees, about 10 degrees, about 15 degrees, and any value or range between any two of the foregoing values. The second angle 522 can be about 10 degrees to about 55 degrees including about 15 degrees, about 30 degrees, about 45 degrees, and any value or range between any two of the foregoing values. The second angle 522 is greater than or equal to the first angle 521. In an embodiment, the first and second angles 521, 522 are different. In a specific example, the first and second angles 521, 522 are 6 degrees and 12 degrees, respectively. In another embodiment, the first and second angles 521, 522 are the same (or approximately the same). As used herein, “about” means plus or minus 10% of the relevant value.

An offset angle 540 is formed between the first and second nozzle caps 511, 512. The offset angle 540 can be measured between the first and second axes 541, 542. The offset angle 540 can range from about 0 degrees to about 45 degrees, including about 10 degrees, about 20 degrees, about 30 degrees, about 40 degrees, and any value or range between any two of the foregoing values. In a specific example, the offset angle 540 can be in the range of about 2 degrees to about 10 degrees, including about 4 degrees, about 6 degrees, about 8 degrees, and any value or range between any two of the foregoing values. When the offset angle 540 is 0 degrees, the first and second nozzle caps 511, 512 (and the first and second axes 541, 542) are parallel to each other.

The pressure and flow rate of the liquid chemicals from the tank 510 can be optimized for the maximum speed of the agricultural vehicle 100 to provide a target volume of chemicals applied per unit area of agricultural field. For example, valve 570 can be set to always open (e.g., 100%) when the agricultural vehicle 100 travels at its maximum speed. When the agricultural vehicle 100 travels slower than its maximum speed, the duty cycle of the valve 570 can be varied such that the same (or approximately the same) target volume of chemicals is applied per unit area of agricultural field. In addition, the frequency of the valve 570 can be varied to reduce or prevent overlap of the spray areas of the first and second nozzle caps 511, 512 and/or to improve spray coverage (e.g., by reducing missed spots during the “off” time of the duty cycle). Examples of the frequency calculation/determination (e.g., by the computer 400) are described herein, for example in step 703 of method 70.

The dual cap nozzle 50 has several technical advantages over a single spray nozzle. One technical advantage is that, when the first and second angles 521, 522 are different, the liquid chemicals are output at different trajectories/angles which can allow the liquid chemicals to be applied to regions of the agricultural field that may be obstructed by bushes, branches, rocks, and/or other obstacles that may be in the flow path of the liquid chemicals output from the first nozzle cap 511 but may not be (or may only be partially obstruct) the liquid chemicals output from the second nozzle cap 512 (or vice versa). Another technical advantage is that the dual cap nozzle 50 provides for more uniform coverage when the valve 570 is operated at duty cycles lower than 100%.

FIG. 5B is a simplified block diagram of a multi-cap nozzle 52 according to an embodiment. Multi-cap nozzle 52 is the same as dual-cap nozzle 50 except that multi-cap nozzle 52 includes two or more nozzle caps while dual-cap nozzle 50 includes only two nozzle caps. When multi-cap nozzle 52 only includes two nozzle caps, multi-cap nozzle 52 is the same as dual-cap nozzle 50.

The multi-cap nozzle 52 can be the same as a broadcast nozzle 421 and/or an SSP nozzle 422. In some embodiments, at least one broadcast nozzle 421 is a multi-cap nozzle 52. In some embodiments, each broadcast nozzle 421 is a respective multi-cap nozzle 52.

Multi-cap nozzle 52 is illustrated as having three nozzle caps 511-513 but can have additional nozzle caps in other embodiments. The third nozzle cap 513 is oriented at a third angle 523 with respect to the vertical axis 530 and away from the direction of travel 550 of the agricultural vehicle 100. The third angle 523 can be measured between the vertical axis 530 and a third axis 543 along which the third nozzle cap 513 extends.

The offset angle 540 in multi-cap nozzle 52 is formed between all nozzle caps 511-513. For example, the offset angle 540 can be measured between the first and third axes 541, 543.

FIG. 5C is a simplified block diagram of a dual-cap nozzle 54 according to an embodiment. Dual-cap nozzle 54 is the same as dual-cap nozzle 50 except that dual-cap nozzle 54 includes first and second valves 571, 572 instead of the single valve 570 in dual-cap nozzle 50. The first valve 571 is fluidly coupled to the first nozzle cap 511. The second valve 572 is fluidly coupled to the second nozzle cap 512. The first and second valves 571, 572 can be located on respective fluid lines 560 to control the flow of liquid chemicals to the respective first and second nozzle caps 511, 512. Alternatively, the first and second valves 571, 572 can be located between the chamber 500 and the respective first and second nozzle caps 511, 512. The chamber 500 can be divided into first and second chambers that are fluidly coupled to the respective first and second nozzle caps 511, 512.

The first and second valves 571, 572 can operate at the same frequency and duty cycle, which can be calculated/determined (e.g., by the computer 400) as discussed herein. The first and second valves 571, 572 can have a variable phase offset that can be determined based, at least in part, speed of the agricultural vehicle, the height of the spray boom (and/or the height of the multi-cap nozzles), and the angle each nozzle cap in the of the multi-cap nozzle. The phase offset can range from 0 degrees (in phase) to 180 degrees (out of phase). The phase offset can be set to vary the overlap and coverage of the respective spray areas of the first and second nozzle caps 511, 512, for example to reduce or minimize overlap between the respective spray areas.

Additional valves can be provided for example such that each nozzle cap 511-513 in multi-cap nozzle 52 (FIG. 5B) has a respective valve, such that the relative phase (e.g., phase offset) of all nozzles and nozzle caps 511-513 can be controllably set.

The dual-cap nozzle 54 can be the same as a broadcast nozzle 421 and/or an SSP nozzle 422. In some embodiments, at least one broadcast nozzle 421 is a dual-cap nozzle 54. In some embodiments, each broadcast nozzle 421 is a respective dual-cap nozzle 54.

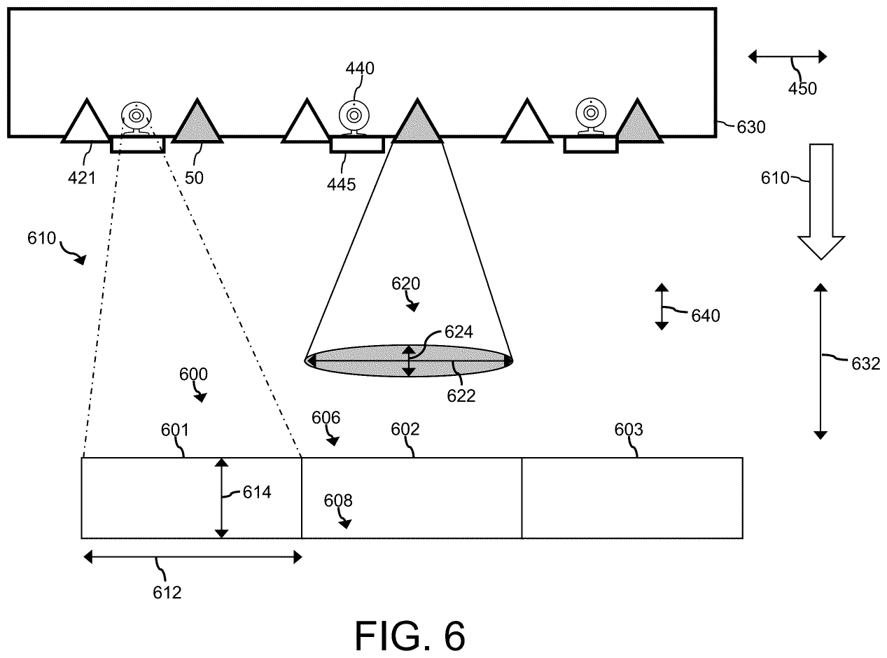

FIG. 6 is a simplified block diagram of a spray boom 630 according to an embodiment. The spray boom 630 is the same as spray boom 130 illustrated in FIG. 4 except that the SSP nozzles 422 are replaced with dual-cap SSP nozzles 50. In another embodiment, one or more SSP nozzles 422 are replaced with one or more respective dual-cap SSP nozzles 50, one or more multi-cap nozzle(s) 52, and/or one or more respective dual-cap SSP nozzles 54

The cameras 440 capture images of a respective field region 601-603 (in general, field region 600) at a predetermined distance in front of the spray boom 630 along its direction of travel 610. The camera 440 can capture images in response to a control signal from the computer 304 (FIG. 3).

The field of view 610 of each camera 440 defines the dimensions of the field regions 600 that are captured in the images. Each field region 600 has a width 612 and a length 614. The width 612 corresponds to and/or is equal to (or approximately equal to (e.g., within about 5%)) a width 622 of a spray area 620 of the respective dual-cap nozzle 50. The widths 612, 622 can be measured with respect to the horizontal axis 450.

The length 614 of each field region 600 can be measured with respect to a length axis 632 (e.g., a second axis) that is parallel to the direction of travel 610. The length axis 632 is orthogonal to the horizontal axis 450 and a vertical axis 640. The vertical axis 640 is parallel to the direction of gravitational pull. The length 614 of each field region 600 can be larger than a corresponding length 624 of the respective field spray area 620 of the respective dual-cap nozzle 50. In other embodiments, the length 614 can be approximately equal to (e.g., within about 5%) the corresponding length 624 of the respective field spray area 620 of the respective spray nozzle 300.

Each spray area 620 is configured to be aligned with the respective field region 600 as the spray boom 630 moves along its direction of travel 610. The computer/controller 400 selectively activates one or more valves 430 when weeds are detected in one or more images of the field regions 600. The computer/controller 400 can activate the valve(s) 430 when at least a portion of the spray area 620 is at the beginning 606 of the respective field region 600. The computer/controller 400 can maintain the valves(s) 430 in the active state until at least a portion of the spray area 620 reaches the end 608 of the respective field region 600 at which point the computer/controller 400 transitions the valve(s) 430 to the inactive state. The length of time that the valve(s) 430 is/are in the active state corresponds to the length 614 of the respective field region 600.

In the active state, the valve(s) 430 can be maintained in the open state or the valve(s) can be opened and closed at a variable frequency and at a variable duty cycle. In the inactive state, the valve(s) 430 are closed.

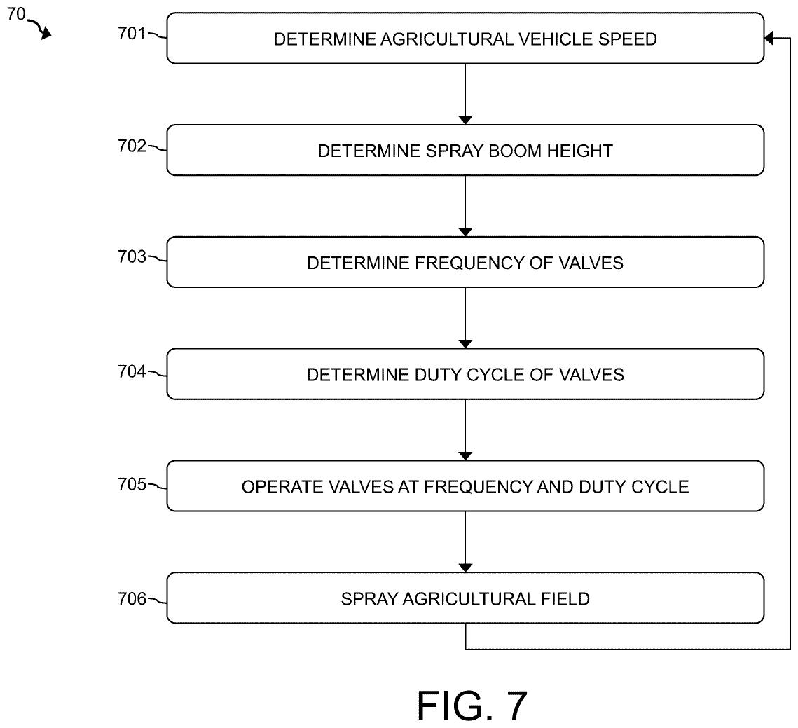

FIG. 7 is a flow chart of a computer-implemented method 70 for operating at least one multi-cap nozzle in a sprayer system. The sprayer system can be a dual-sprayer system (e.g., dual-sprayer system 10, 20) or a single-sprayer system. The multi-cap nozzle(s) can be the same as dual-cap nozzle(s) 50, multi-cap nozzle(s) 52, and/or dual-cap nozzle(s) 54.

In step 701, the computer or controller (in general, computer) determines the speed of the agricultural vehicle (e.g., agricultural vehicle 100, 310). The computer can be in electrical communication with the speedometer of the agricultural vehicle to determine its speed. Additionally or alternatively, the computer can include or can be electrically coupled to a GPS circuit and can determine the speed using the GPS coordinates of the agricultural vehicle as a function of time. The computer can be the same as or different than computer 400 and/or computing device 304.

In step 702, the computer determines the height of the spray boom and/or the height of the multi-cap nozzles. The height of the spray boom can be determined using one or more sensors on the spray boom that is/are in communication with the computer. Example sensors can include LIDAR (Light Detection and Ranging), radar, lasers, ultrasound, and/or other sensors.

In step 703, the computer determines the frequency of the valves (e.g., valves 430 and/or valves 432). The computer can determine the frequency of the valves using as inputs the current speed of the agricultural vehicle, the height of the spray boom (and/or the height of the multi-cap nozzles), and the angle of each nozzle cap in the of the multi-cap nozzle (e.g., first, second, and/or third angles 521-523). The offset angle can be used instead of the angle of each nozzle cap.

The frequency can be set to minimize overlap of the spray areas of the first and second nozzle caps. Additionally or alternatively, the frequency can be set to set to improve or maximize spray coverage at low speeds and/or duty cycles.

In a first example frequency calculation, the height of the spray boom is 100 cm (1 m) and the current speed of the agricultural vehicle is 3 meters per second (m/s). The multi-cap nozzle is dual-cap nozzle with a first nozzle cap angle of 6 degrees and a second nozzle cap angle of 12 degrees. Using a geometric model, the system can determine that an axis (e.g., the first axis 541 (FIG. 5A)) through the first nozzle cap at the first nozzle cap angle (6 degrees) intersects the ground at 0.105 meters behind the spray boom. Similarly, the system can determine that an axis (e.g., the second axis 542 (FIG. 5A)) through the second nozzle cap at the second nozzle cap angle (12 degrees) intersects the ground at 0.210 meters behind the spray boom. The distance between the points of intersection is 0.105 meters, which takes 0.035 seconds to travel at the agricultural vehicle's current speed.

The system can be set to calculate the frequency such that a default number of frequency cycles occur in the time period (0.026 seconds) to travel the distance between these points of intersection. The default number can be 1 frequency cycle, 1.5 frequency cycles, 2 frequency cycles, 2.5 frequency cycles, 3 frequency cycles, 3.5 frequency cycles, and/or another number of frequency cycles. If the default is 1.5 frequency cycles, the period (T) of the frequency is determined as 0.035/1.5 or 0.023 seconds/cycle. The frequency is the inverse of T, i.e., 43 Hz.

In general, the frequency can be calculated using Equations 1-6. In Equations 1 and 2, the first and second nozzle cap angles are converted from degrees (Angle1_{deg} and Angle2_{deg}) to milliradians (Angle1_{mrad} and Angle2_{mrad}).

$$Angle {1}_{mrad} = \frac{π \cdot Angle {1}_{deg}}{180} \cdot 1000 \qquad ( 1 )$$

$$Angle {2}_{mrad} = \frac{π \cdot Angle {2}_{deg}}{180} \cdot 1000 \qquad ( 2 )$$

In Equation 3, the distance between the locations where the axes that pass through the first and second nozzle caps is determined as a function of the spray-boom height (Height) and the first and second nozzle cap angles.

$$Distance = Height ( \frac{Angle {2}_{mrad} - Angle {1}_{mrad}}{1000} ) \qquad ( 3 )$$

In Equation 4, the time for the spray boom to travel the distance calculated in Equation 3 at the current speed (Speed) is determined.

$$Time = \frac{Distance}{Speed} = \frac{Height ( \frac{Angle {2}_{mrad} - Angle {1}_{mrad}}{1000} )}{Speed} \qquad ( 4 )$$

In Equation 5, the period (T) is determined as the ratio of the time calculated in Equation 4 and the number of cycles that will occur within that time.

$$T = \frac{Time}{Cycles} = \frac{Height ( \frac{Angle {2}_{mrad} - Angle {1}_{mrad}}{1000} )}{Speed} \cdot \frac{1}{Cycles} \qquad ( 5 )$$

In Equation 6, the frequency is determined as inverse of the period calculated in Equation 5.

$$Frequency = \frac{1}{T} = \frac{Speed \cdot Cycles}{Height ( \frac{Angle {2}_{mrad} - Angle {1}_{mrad}}{1000} )} \qquad ( 6 )$$

The values from the first example frequency calculation are substituted into Equation 6, as illustrated in Equation 7.

$$Frequency = \frac{3 \frac{m}{s} \cdot 1.5 cycles}{1 m ( \frac{209 mrad - 105 mrad}{1000} )} = 43 Hz \qquad ( 7 )$$

Assuming that the maximum/optimum speed of the agricultural vehicle is 6 m/s, the duty cycle is 50%, which results in an equivalent “on” distance of 0.035 meters and an equivalent “off” distance of 0.035 meters at 43 Hz. The equivalent on distance is the distance that the agricultural vehicle during the “on” portion of each duty cycle. The equivalent off distance is the distance that the agricultural vehicle during the “off” portion of each duty cycle.

In a second example frequency calculation, the current speed of the agricultural vehicle is 4 m/s with the other inputs are the same as in the first example. As in the first example, the distance between the points of intersection is 0.105 meters, which takes 0.026 seconds to travel at the agricultural vehicle's current speed of 4 m/s. If the default is 1.5 frequency cycles, the period (T) of the frequency is determined as 0.026/1.5 or 0.017 seconds/cycle. The frequency is the inverse of T, i.e., 57.3 Hz.

Assuming that the maximum/optimum speed of the agricultural vehicle is 6 m/s, the duty cycle is 66%, which results in an equivalent “on” distance of 0.047 meters and an equivalent “off” distance of 0.023 meters at 57.3 Hz.

In a third example frequency calculation, the current speed of the agricultural vehicle is 2 m/s with the other inputs are the same as in the first example. As in the first example, the distance between the points of intersection is 0.105 meters, which takes 0.052 seconds to travel at the agricultural vehicle's slower speed of 2 m/s. If the default is 1.5 frequency cycles, the period (T) of the frequency is determined as 0.052/1.5 or 0.035 seconds/cycle. The frequency is 1.5 the inverse of T, i.e., 28.7 Hz.

Assuming that the maximum/optimum speed of the agricultural vehicle is 6 m/s, the duty cycle is 33%, which results in an equivalent “on” distance of 0.023 meters and an equivalent “off” distance of 0.047 meters at 28.7 Hz.

In some embodiments, a maximum “off” distance can be set. An example maximum “off”′ distance is 0.025 meters, though other distances can be used (e.g., in the range of about 0.02 meters to about 0.05 meters). When the calculated equivalent “off” distance is higher than the maximum “off” distance, the system can re-calculate the frequency by increasing the number of frequency cycles that will occur in the distance between the points of intersection. For example, the number of frequency cycles can be increased from 1.5 (default) to 2.5, which results in a frequency of 47.8 Hz. At this frequency and at 33% duty cycle, the equivalent “on” distance of 0.014 meters and an equivalent “off” distance of 0.028 meters. Since the new equivalent “off” distance (0.028 meters) is higher than the example maximum “off” distance (0.025 meters), the system can re-calculate the frequency by increasing the number of frequency cycles that will occur in the distance between the points of intersection from 2.5 to 3.5.

Increasing the number of frequency cycles to 3.5 cycles results in a frequency of 66.9 Hz. The equivalent “on” distance is now 0.010 meters and the equivalent “off” distance is now 0.020 meters. Since the new equivalent “off” distance (0.020 meters) is lower than the example maximum “off” distance (0.025 meters), system can use the 66.9 Hz frequency to operate the valves.

Those of skill in the art will appreciate that other examples can be provided and the above examples are not intended to be limiting. It is also noted that other limits can be used instead of (or in addition to) the maximum “off” distance. For example, a minimum frequency can be used.

An advantage of operating at relatively low frequencies is that the valves can withstand higher operating pressures of the fluid lines and the valves will have increased reliability (e.g., less wear and tear).

In step 704, the computer determines the duty cycle of the valves (e.g., valves 430 and/or valves 432). The computer can determine the duty cycle of the valves using as inputs the current speed of the agricultural vehicle and the maximum (or optimized speed) of the agricultural vehicle. The maximum speed can be stored in computer memory (e.g., non-volatile computer memory) that is operatively coupled to the computer. Alternatively, the computer can compare the current speed of the agricultural vehicle with the optimized speed at which the pressure and flow rate of the liquid chemicals are optimized (e.g., to provide a target volume of chemicals applied per unit area of agricultural field). The optimized speed can be the same or different than the maximum speed of the agricultural vehicle.

In a simplified example, the duty cycle can be determined using Equation 8.

$$Duty Cycle = \frac{Current Speed}{Maximum Speed} \qquad ( 8 )$$

For example, when the current speed is half of the maximum speed, the duty cycle can be 0.5 or 50%. The duty cycle can be varied so that the dual-cap nozzles spray about the same target volume of liquid chemicals per unit area of the agricultural field regardless of the speed of the agricultural vehicle.

In step 705, the valves (e.g., valves 430 and/or valves 432) are operated at the frequency and duty cycle determined in steps 703 and 704.

In step 706, the multi-cap nozzle(s) spray the agricultural field at the frequency and duty cycle of the valves.

Steps 701-706 can repeat in a loop while the agricultural vehicle is in motion and/or while the multi-cap nozzle(s) is/are operational. In some embodiments, one or more multi-cap SSP nozzles is/are activated when a target growth, such as weeds or a target crop, is detected (e.g., by cameras 440) in which case method 70 is performed for only the activated multi-cap nozzles while the SSP valves for the inactivated dual-cap SSP nozzles remain closed. The broadcast nozzles can be activated and deactivated independently of the state of the SSP nozzles. The broadcast nozzles can include one or more multi-cap broadcast nozzles that can spray at the frequency and duty cycle of the respective valves, which can be determined using method 70.

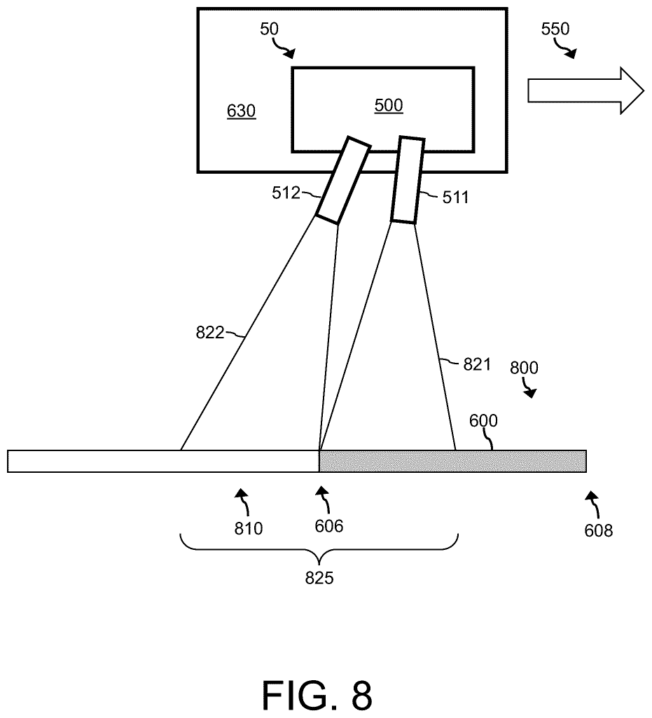

FIG. 8 is a simplified end view of spray boom 630 illustrated in FIG. 6 when one of a dual-cap nozzle 50, 54 (or a multi-cap nozzle 52) is aligned with the beginning 606 of a field area 600 in which one or more weeds is/are detected. A field area 600 to be sprayed can be referred to as a target field area 800.

In an embodiment, the dual-cap nozzle 50, 54 (or multi-cap nozzle 52) can be activated when a first spray area 821 of the first nozzle cap 511 is aligned with the beginning 606 of the target field area 800. When the dual-cap nozzle 50, 54 (or multi-cap nozzle 52) is activated, the second spray area 822 of the second nozzle cap 512 is aligned with a proximal portion 810 of the agricultural field. The proximal portion 810 is adjacent to and neighboring the target field area 800 in the direction away from the direction of travel 610. The proximal portion 810 is not included in the image of the target field area 800. A combined spray area 825 of the dual-cap nozzle 50, 54 (or multi-cap nozzle 52) is the combination of at least the first and second spray areas 821, 822.

The second spray area 822 will be aligned with the beginning 606 of the target field area 800 as the spray boom 630 is moved along the direction of travel 550, such that the same portions of the target field area 800 will be sprayed by both the first and second nozzle caps 511, 512 at different times and at different angles. The variation in spray angles increases the likelihood of successfully spraying around any obstructions (e.g., branches, rocks, etc.) that may be on the target field area 800.

Thus, when the dual-cap nozzle 50, 54 (or multi-cap nozzle 52) is activated, only first spray area 821 of the first nozzle cap 511 is aligned with and sprays the beginning 606 of the target field area 800 and only the second spray area 822 of the second nozzle cap 512 is aligned with and sprays the proximal portion 810 of the agricultural field. After the second spray area 822 of the second nozzle cap 512 sprays the proximal portion 810 of the agricultural field, the second spray area 822 of the second nozzle cap 512 sprays the beginning 606 of the target field area 800 as the agricultural vehicle travels along the direction of travel 610.

Some or all of the dual-cap nozzles 50, 54 (or multi-cap nozzle 52) on spray boom 630 can be operated according to this embodiment.

A technical advantage of this embodiment is that the length of the sprayed area of the agricultural field is increased compared to when only the target field area 800 is sprayed. The increased length of the spray area can improve coverage and reduce and/or eliminate spray and/or detection inaccuracies.

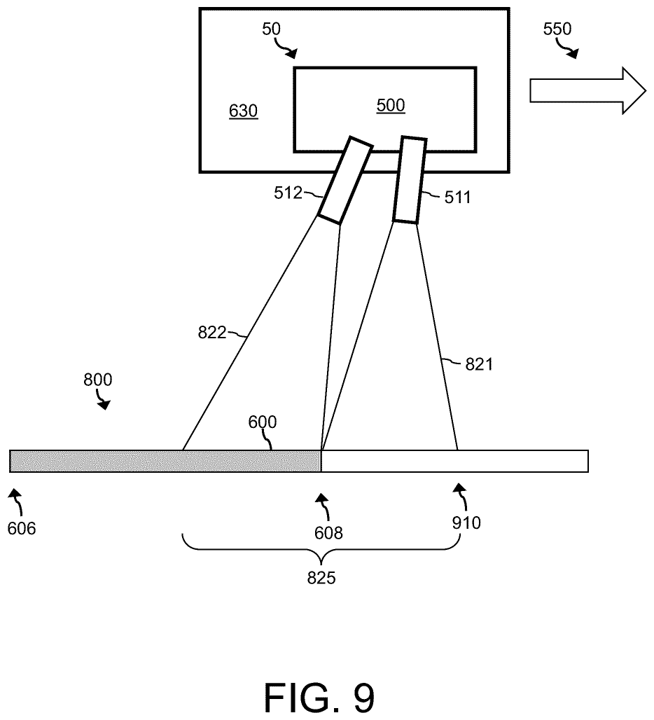

FIG. 9 is a simplified end view of spray boom 630 illustrated in FIG. 6 when one of the dual-cap nozzles 50, 54 (or multi-cap nozzle 52) is aligned with the end 608 of a target field area 800 in which one or more weeds is/are detected.

In an embodiment, the dual-cap nozzle 50, 54 (or multi-cap nozzle 52) can remain activated until the second spray area 822 of the second nozzle cap 512 is aligned with the end 608 of the target field area 800. When the second spray area 822 of the second nozzle cap 512 is aligned with the end 608 of the target field area 800, the first spray area 821 of the first nozzle cap 511 is aligned with a distal portion 910 of the agricultural field. The distal portion 910 is adjacent to and neighboring the target field area 800 in the direction of travel 610. The distal portion 910 is not included in the image of the target field area 800.

Thus, when the dual-cap nozzle 50, 54 (or multi-cap nozzle 52) remains activated until only the second spray area 822 of the second nozzle cap 512 is aligned with and sprays the end 608 of the target field area 800 and only the first spray area 821 of the first nozzle cap 511 is aligned with and sprays the distal portion 910 of the agricultural field. The first spray area 821 of the first nozzle cap 511 sprayed the end 608 of the target field area 800 before spraying the distal portion 910 of the agricultural field.

Some or all of the dual-cap nozzles 50, 54 (or multi-cap nozzle 52) on spray boom 630 can be operated according to this embodiment.

A technical advantage of this embodiment is that the length of the sprayed area of the agricultural field is increased compared to when only the target field area 800 is sprayed. The increased length of the spray area can improve coverage and reduce and/or eliminate spray and/or detection inaccuracies.

The embodiments illustrated in FIGS. 8 and 9 can be combined such that the dual-cap nozzle(s) 50, 54 (or multi-cap nozzle 52) is/are activated when the first spray area 821 of the first nozzle cap 511 is aligned with the beginning 606 of the target field area 800 (e.g., as illustrated in FIG. 8) and remain activated until the second spray area 822 of the second nozzle cap 512 is aligned with the end 608 of the target field area 800 (e.g., as illustrated in FIG. 9), at which point the dual-cap nozzle(s) 50, 54 (or multi-cap nozzle 52) is/are transitioned to the inactive state (unless spraying is needed for subsequent neighboring field areas).

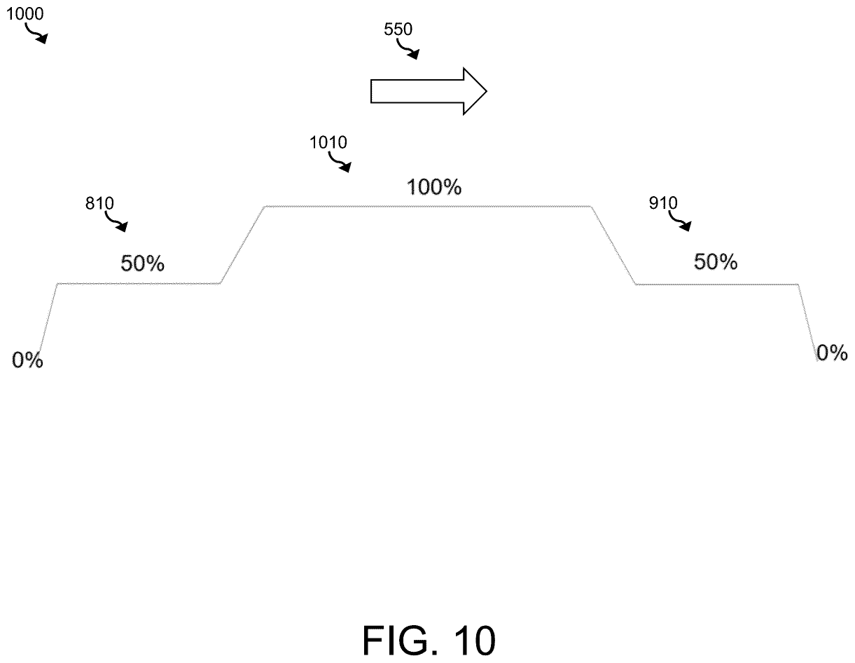

FIG. 10 is a graph 1000 that represents the spatial volumetric distribution of spray in the embodiment illustrated in FIGS. 8 and 9. The target spray area 1010 (e.g., field area 600) receives about 100% of the volume of spray from the dual-cap nozzle 50, 54 (or multi-cap nozzle 52) since both the first and second spray areas 821, 822 reach the target spray area 1010 as the spray boom is moved along the direction of travel 610. The proximal and distal portions 810, 910 receive about 50% of the volume of spray from the dual-cap nozzle 50, 54 since only one of the first and second spray areas 821, 822 reaches the proximal and distal portions 810, 910. For example, only the second spray area 822 reaches the proximal portion 810 and only the first spray area 821 reaches the distal portion 910.

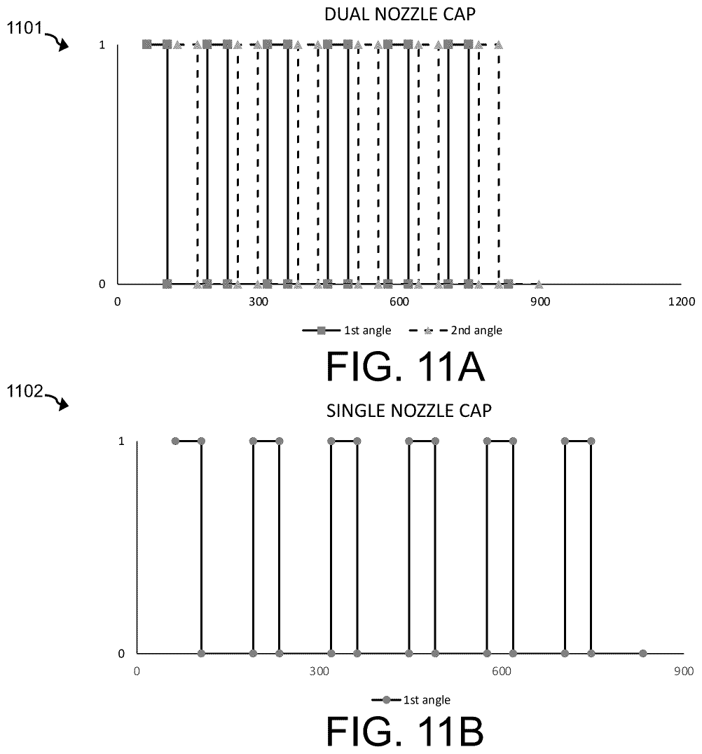

FIGS. 11A and 11B illustrates example graphs 1101, 1102 that model a dual-cap nozzle and a single-cap nozzle, respectively, operated at a 50% duty cycle at a frequency of 35 Hz. The horizontal axis represents spatially where the liquid chemicals are applied on the agricultural field as a function of time. The vertical axis of each graph 1101, 1002 represents the state of each valve where a value of 1 is on/open and a value of 0 is off/closed. The first angle is modeled as 6 degrees and the second angle is modeled as 12 degrees. The height of the dual-cap nozzle is modeled as 600 mm (about 2 feet). The spray boom is modeled as travelling at 3 meters per second with a maximum speed of 6 meters per second.

In graph 1101, there is a spatial offset between the first and second angles (first and second caps, respectively) because the second angle is larger than the first angle and thus reaches the agricultural field later and further away from the dual-cap nozzle than the first angle.

As can be seen, the dual-cap nozzle (in graph 1101) provides near 100% spatial coverage at a 50% duty cycle while the single-cap nozzle (in graph 1102) provides only 50% spatial coverage at a 50% duty cycle. Increased spatial coverage occurs because the volumetric flow rate through each nozzle cap of the dual-cap nozzle is half the volumetric flow rate of the single-cap nozzle, which allows one of the dual-cap nozzle cap to almost always be “on.”

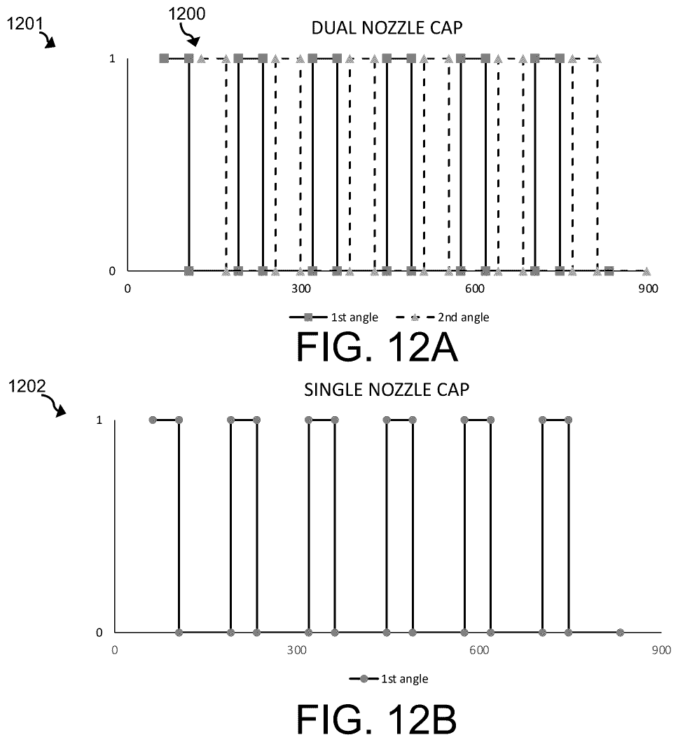

FIGS. 12A and 12B illustrates example graphs 1201, 1202 that model a dual-cap nozzle and a single-cap nozzle, respectively, operated at a 33% duty cycle. The horizontal and vertical axes in graphs 1201, 1202 represent the same information as in graphs 1101, 1102. The model is the same as in graphs 1101, 1102 except that the duty cycle is 33% instead of 50%, which can corresponds to a spray boom travelling at 2 meters per second with a maximum speed of 6 meters per second Even at a 33% duty cycle, the dual-cap nozzle (in graph 1201) provides at least approximately 90% spatial coverage (e.g., with small spatial gaps 1200) while the single-cap nozzle (in graph 1202) provides only 33% spatial coverage.

A technical advantage of the dual-cap nozzle is that it provides more uniform coverage with variable duty cycles compared to the single-cap nozzle.

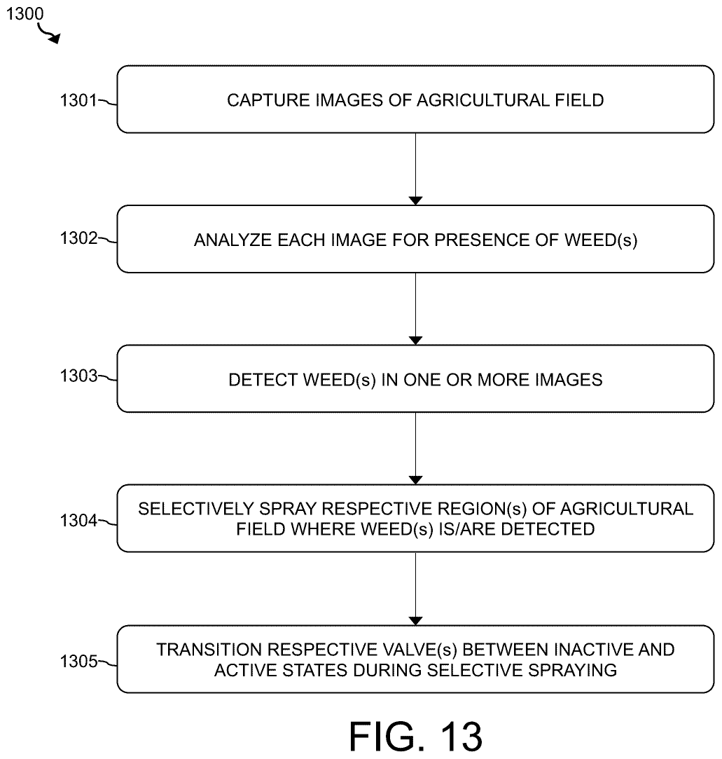

FIG. 13 is a flow chart of a method 1300 for selectively spraying an agricultural field according to an embodiment.

In step 1301, images of respective regions of an agricultural field are captured using image sensors (e.g., cameras) mounted on a spray boom, which is attached to an agricultural vehicle.

In step 1302, the captured images are automatically analyzed to determine with one or more weeds is/are present. The captured images can be analyzed using one or more trained machine learning models that can be implemented on a computer.

In step 1303, one or more weeds is/are automatically detected in one or more of the captured images.

In step 1304, the target region(s) in which the weed(s) is/are detected are selectively sprayed using one or more multi-cap nozzles that is/are associated with the image(s) where weed(s) is/are detected and/or that is/are associated with the corresponding image sensors.

In step 1305, the respective valve(s) for the multi-cap nozzle(s) is/are transitioned from an inactive state to an active state to selectively spray the target region(s). In the inactive state, the valve(s) is/are closed such that fluid from the SSP tank is obstructed and cannot reach the multi-cap nozzle(s). In the active state, the valve(s) is/are opened such that fluid from the SSP tank can flow to and out of the multi-cap nozzle(s). While in the active state, the valve(s) can be opened and closed at a variable frequency and a variable duty cycle, as described herein.

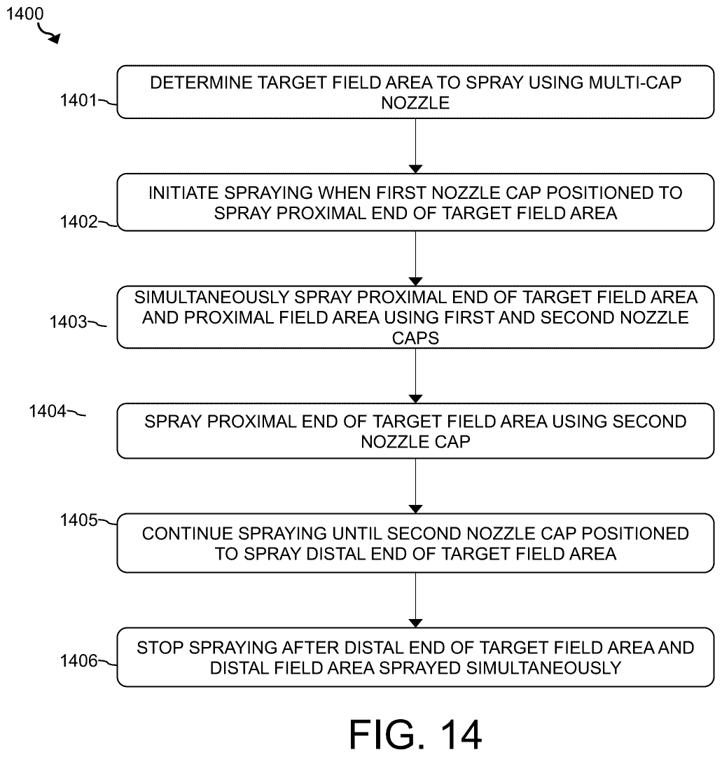

FIG. 14 is a flow chart of a method 1400 for spraying a target field area of an agricultural field using a multi-cap nozzle according to an embodiment.

In step 1401, a computer (e.g., computing device 304) determines a target field area 800 to spray using a multi-cap nozzle (e.g., dual-cap nozzle 50, 54 or multi-cap nozzle 52). The target field area can be determined using images and a trained ML model, historical data (e.g., stored in data repository 314), and/or user input. The GPS coordinates of the target field area 800 can be determined in some embodiments.

In step 1402, spraying of the target field area is initiated when a first nozzle cap 511 of the multi-cap nozzle is positioned to spray a beginning 606 and/or a proximal end of the target field area 800. When the first nozzle cap 511 is positioned to spray a beginning 606 and/or a proximal end of the target field area 800, a second nozzle cap 512 is positioned to spray a proximal portion 810 of the agricultural field.

In step 1403, the beginning 606 and/or the proximal end of the target field area 800 and the proximal portion 810 are sprayed simultaneously using the first and second nozzle caps 511, 512, respectively of the multi-cap nozzle.

In step 1404, the beginning 606 and/or the proximal end of the target field area 800 is/are sprayed using the second nozzle cap 512 as the agricultural vehicle moves along a direction of travel 550.

In step 1405, spraying is continued until the second nozzle cap 512 is positioned to spray an end 608 and/or a distal end of the target field area 800. When the second nozzle cap 512 is positioned to spray the end 608 and/or the distal end of the target field area 800, the first nozzle cap 511 is positioned to spray a distal portion 910 of the agricultural field.

In step 1406, spraying is stopped after the distal portion 910 of the agricultural field and the end 608 and/or the distal end of the target field area 800 are sprayed simultaneously using the first and second nozzle caps 511, 512, respectively of the multi-cap nozzle. Immediately before spraying the distal portion 910 of the agricultural field, the first nozzle cap 511 sprays the end 608 and/or the distal end of the target field area 800.

Thus, all areas of the target field area 800 are sprayed twice (once each by the first and second nozzles 511, 512) while the proximal portion 810 and the distal portion 910 are sprayed once (by the second and first nozzles 512, 511, respectively). This provides an undershoot and an overshoot of the target field area 800, which can be useful to improve coverage and reduce and/or eliminate spray and/or detection inaccuracies. Based on a relative spray volume of 100% for the target field area 800, the proximal portion 810 and the distal portion 910 are sprayed at a relative spray volume of 50%, for example as illustrated in FIG. 10.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A multi-cap nozzle comprising:
a housing having a cavity to receive a liquid;
a first nozzle cap attached to the housing, the first nozzle cap defining a first nozzle channel that is fluidly coupled to the cavity; and
a second nozzle cap attached to the housing, the second nozzle cap defining a second nozzle channel that is fluidly coupled to the cavity,
wherein:
the first and second nozzle caps extend along first and second axes, respectively, and
an offset angle between the first and second axes is greater than or equal to about 0 degrees and less than or equal to about 45 degrees.

2. The multi-cap nozzle of claim 1, wherein:
the first axis is oriented at a first angle with respect to a vertical axis, the first angle greater than or equal to about 0 degrees and less than or equal to about 20 degrees,
the second axis is oriented at a second angle with respect to the vertical axis, the second angle greater than or equal to about 10 degrees and less than or equal to about 55 degrees, and
the second angle is greater than or equal to the first angle.

3. The multi-cap nozzle of claim 2, wherein the first angle is about 6 degrees and the second angle is about 12 degrees.

4. The multi-cap nozzle of claim 1, wherein the offset angle is greater than or equal to about 2 degrees and less than or equal to about 10 degrees.

5. The multi-cap nozzle of claim 1, further comprising:
a third nozzle cap attached to the housing, the third nozzle cap defining a third nozzle channel that is fluidly coupled to the cavity,
wherein:
the third nozzle cap extends along a third axis, and
the offset angle is between the first, second, and third axes.

6. An agricultural spray system comprising:
an agricultural vehicle;
a tank mounted on the agricultural vehicle, the tank configured to hold one or more liquid chemicals for treating weeds in an agricultural field;
a spray boom attached to the agricultural vehicle, the spray boom extending along a horizontal axis; and
at least one multi-cap nozzle mounted on the spray boom, each multi-cap nozzle fluidly coupled to the tank and comprising:
a housing having a cavity to receive the one or more specific liquid chemicals;
a first nozzle cap attached to the housing, the first nozzle cap defining a first nozzle channel that is fluidly coupled to the cavity; and
a second nozzle cap attached to the housing, the second nozzle cap defining a second nozzle channel that is fluidly coupled to the cavity,
wherein:
the first and second nozzle caps extend along first and second axes, respectively, and
an offset angle between the first and second axes is greater than or equal to about 0 degrees and less than or equal to about 45 degrees.

7. The spray system of claim 6, wherein:
the first axis is oriented at a first angle with respect to a vertical axis, the vertical axis orthogonal to the horizontal axis, the first angle greater than or equal to about 0 degrees and less than or equal to about 20 degrees,
the second axis is oriented at a second angle with respect to the vertical axis, the second angle greater than or equal to about 10 degrees and less than or equal to about 55 degrees, and
the second angle is greater than or equal to the first angle.

8. The spray system of claim 7, wherein the first angle is about 6 degrees and the second angle is about 12 degrees.

9. The spray system of claim 6, wherein the first and second nozzle caps are oriented away from a direction of travel of the agricultural vehicle.

10. The spray system of claim 6, further comprising:
at least one fluid line, each fluid line fluidly coupling a respective multi-cap nozzle to the tank;
at least one valve, each valve fluidly coupled to a respective fluid line and having an open state in which fluid flows from the tank to the respective multi-cap nozzle and a closed state in which a flow of the fluid from the tank to the respective multi-cap nozzle is obstructed; and
one or more processors in electrical communication with the valve(s), the processor(s) configured to cause the valve(s) to transition between the open state and the closed state at a frequency and a duty cycle that minimizes an overlap between a first spray area of the first nozzle cap and a second spray area of the second nozzle cap.

11. The spray system of claim 10, wherein:
the processor(s) is/are configured to dynamically determine the frequency as a function of a current speed of the agricultural vehicle, a current height of the spray boom, and the first and second angles, and
the processor(s) is/are configured to dynamically determine the duty cycle as a function of the current speed of the agricultural vehicle and a maximum speed of the agricultural vehicle.

12. The spray system of claim 10, wherein:
the processor(s) is/are configured to cause at least one of the valve(s) to transition to the open state when the second nozzle cap is positioned to spray a proximal end of a target field area and the first nozzle cap is positioned to spray a proximal field area, the agricultural vehicle reaching the proximal field area before the target field area as the agricultural vehicle moves along the direction of travel,
the processor(s) is/are configured to cause the at least one of the valve(s) to the closed state after the first nozzle cap sprays a distal end of the target field area and the second nozzle cap sprays a distal field area, the agricultural vehicle reaching the distal field area after the target field area as the agricultural vehicle moves along the direction of travel, and
the target field area is between and neighboring the proximal field area and the distal field area.

13. The spray system of claim 10, further comprising:
a plurality of image sensors mounted on the spray boom and configured to capture images of the agricultural field in a direction of travel of the agricultural vehicle, each image sensor having a field of view that is aligned with and corresponds with one or more of the multi-cap nozzles; and
one or more computers in electrical communication with the image sensors to receive captured images from the image sensors, the computer(s) configured to detect target weed(s) in one or more of the captured images using a trained machine learning (ML) model, the trained ML model having been trained with first and second training images of agricultural fields, the first training images including the target weed(s), the second training images not including the target weed(s), the computer(s) producing an output signal that causes one or more of the valves to transition between an inactive state and an active state, the one or more valves associated with the one or more of the captured images in which the target weed(s) is/are detected,
wherein:
in the inactive state, the one or more valves are in the closed state,
in the active state, the one or more valves transition between the open state and the closed state at the frequency and the duty cycle,
the field of view of each image sensor has a respective width and a respective length to define a respective field area, the respective width corresponding to a spray width of a respective multi-cap nozzle, the respective length corresponding to a length of time that a respective valve for the respective multi-cap nozzle is in the active state,
the respective width is measured with respect to the horizontal axis,
the respective length is measured with respect to a length axis that is orthogonal to the horizontal axis and to a vertical axis,
when the respective valve transitions from the inactive state to the active state at a beginning of the length of time, only the first nozzle cap of the respective multi-cap nozzle sprays the proximal field area, and
when the respective valve transitions from the active state to the inactive state at an end of the length of time, only the second nozzle cap of the respective multi-cap nozzle sprays the distal field area.

14. The spray system of claim 13, wherein the tank comprises a selective-spot spray (SSP) tank configured to hold one or more specific liquid chemicals for treating one or more target weeds growing in the agricultural field.

15. The spray system of claim 14, further comprising:
at least one fluid line, each fluid line fluidly coupling a respective multi-cap nozzle to the SSP tank;
respective first and second valves associated with each multi-cap nozzle, the respective first valve fluidly coupled to a respective first nozzle cap, the respective second valve fluidly coupled to a respective second nozzle cap; and
one or more processors in electrical communication with the respective first and second valves of each multi-cap nozzle, the processor(s) configured to transition the respective first and second valves of each multi-cap nozzle between a respective open state and a respective closed state at a frequency, a duty cycle, and a relative phase that minimizes an overlap between a respective first spray area of the respective first nozzle cap and a respective second spray area of the respective second nozzle cap.

16. The spray system of claim 6, wherein the tank comprises a broadcast tank configured to hold one or more general-application liquid chemicals for preventing the weeds from growing.

17. A method for spraying an agricultural field, comprising:
in a system that includes a spray boom attached to an agricultural vehicle, and at least one multi-cap nozzle mounted on the spray boom, each multi-cap nozzle fluidly coupled to a tank mounted on the agricultural vehicle through a respective valve, the tank configured to hold one or more liquid chemicals for treating weeds in the agricultural field, wherein each multi-cap nozzle comprises:
a housing having a cavity to receive the one or more specific liquid chemicals;
a first nozzle cap attached to the housing, the first nozzle cap defining a first nozzle channel that is fluidly coupled to the cavity; and
a second nozzle cap attached to the housing, the second nozzle cap defining a second nozzle channel that is fluidly coupled to the cavity,
wherein:
the first and second nozzle caps extend along first and second axes, respectively, and
an offset angle between the first and second axes is greater than or equal to about 0 degrees and less than or equal to about 45 degrees,
the method comprising:
determining, with a controller for the multi-cap nozzle(s), a current speed of the agricultural vehicle;
determining, with the controller, a current height of the spray boom;
determining, with the controller and using at least the current height, the current speed, and the offset angle, a frequency to transition the respective valve between an open state and a closed state that minimizes an overlap between a first spray area of the first nozzle cap and a second spray area of the second nozzle cap;
determining, with the controller and using at least the current speed, a duty cycle of the respective valve; and
spraying the agricultural field using each multi-cap nozzle at the frequency and duty cycle of the respective valve.

18. The method of claim 17, wherein the duty cycle is determined using the current speed and a maximum speed of the agricultural vehicle.

19. The method of claim 18, wherein the duty cycle is calculated as a ratio of the current speed and the maximum speed.

20. The method of claim 17, further comprising dynamically varying the frequency as a function of a current speed of the agricultural vehicle, a current height of the spray boom, and the offset angle.

21. The method of claim 20, further comprising:
determining an equivalent distance that the agricultural vehicle travels during an off portion of the duty cycle at the current speed; and
when the equivalent distance is larger than a maximum off distance, dynamically increasing the frequency until the equivalent distance is lower than the maximum off distance.

22. The method of claim 17, further comprising:
automatically capturing, with a plurality of cameras attached to the spray boom, a respective image of a respective region of an agricultural field, each region at a predetermined distance from the spray boom, each image associated with a respective multi-cap nozzle;
automatically analyzing, with a trained machine learning (ML) model running on a computer, each image for a presence of at least one target weed, the trained ML model having been trained with first and second training images of agricultural fields, the first training images including the target weed(s), the second training images not including the target weed(s);
automatically detecting, with the trained ML model, the at least one target weed in one or more images; and
automatically selectively spraying one or more of the respective regions of the agricultural field using one or more of the multi-cap nozzle(s) associated with the one or more images where the at least one target weed is detected.
